(19) United States
(12) Patent Application Publication
(10) Pub. No.: US 2020/0033568 A1
(43) Pub. Date: Jan. 30, 2020

(54) Projection Lens

(71) Applicant: AAC Acoustic Technologies (Shenzhen) Co., Ltd., Shenzhen (CN)

(72) Inventor: Zhiying Liu, Shenzhen (CN)

(21) Appl. No.: 16/516,336

(22) Filed: Jul. 19, 2019

(30) Foreign Application Priority Data
Jul. 24, 2018 (CN) 201810821356.X

(51) Int. Cl. G02B 13/16; G02B 15/177; G02B 9/14

(52) U.S. Cl. CPC G02B 13/16; G02B 9/14; G02B 15/177

(57) ABSTRACT

The present disclosure discloses a projection lens. The projection lens includes, from an object side to an image side in sequence: an object surface, a first lens with a positive refractive power, a second lens with a negative refractive power, and a third lens with a positive refractive power. The projection lens further satisfies the following conditions: 0.95≤f/TTL≤2; 0.22≤Te/TTL≤0.3; where f: focal length of the projection lens; TTL: the total distance from the object side surface of the first lens to the image plane along the optic axis; Te: distance from the object surface to an edge of the first lens.

### FIELD OF THE PRESENT DISCLOSURE

The present disclosure relates to optical lens, in particular to a projection lens suitable for handheld devices such as smart phones and digital cameras and imaging devices.

### DESCRIPTION OF RELATED ART

With the emergence of smart phones in recent years, the demand for miniature camera lens is increasing day by day, but the photosensitive devices of general camera lens are no other than Charge Coupled Device (CCD) or Complementary metal-Oxide Semiconductor Sensor (CMOS sensor), and as the progress of the semiconductor manufacturing technology makes the pixel size of the photosensitive devices shrink, coupled with the current development trend of electronic products being that their functions should be better and their shape should be thin and small, miniature camera lens with good imaging quality therefor has become a mainstream in the market.

Along with the rapid development of the smart phone, the camera shooting function of the mobile phone continuously comes out of the innovation technology, like 3D imaging technology. The optical sensing technology based on the 3D structured light, can be used for human faces, gesture recognition and enhanced photographing functions, and brings new AR application. The optical image is converted from the past two-dimensional direction to the three-dimensional space, so that more real and clear sensing experience is brought.

The 3D structured light is acquired by a camera after the specific laser information is projected to the surface of an object, information such as the position and depth of the object is calculated according to the change of the light information caused by the object, and then the whole three-dimensional space is restored. The specific laser information is an important index in the 3D structured light technology, so that the requirement for projecting the laser information to the surface of the object to be measured is very high. A projector providing an array point light source with a specific solid angle emitted by a surface of VCSEL (Vertical Cavity Surface Emitting Laser) is a key link of 3D imaging quality.

In an existing projection lens type product, the change of the environment temperature leads to the change of the focal length f of the lens. The angle of the projection light of the lens can be obviously changed, and original light information can be changed. Therefore, the calculation of the whole system will be error, and the contour restoration precision of the three-dimensional object is influenced. The problem that as the ambient temperature changes, the image point of the projection becomes large is also bigger. And the definition of the system reducing three-dimensional object can also be reduced. In order to effectively reduce the length of the system, the design tolerance of the system structure should be improved, and the sensitivity of the focal length caused by the environment temperature should be reduced, based on which the present disclosure provides an improved camera lens.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is an illustrative structural view of a projection lens in accordance with a first exemplary embodiment of the present disclosure.

FIG. 2 is a distortion curve of the projection lens in FIG. 1.

FIG. 3 is a spot diagram of the projection lens in FIG. 1.

FIG. 4 is an illustrative structural view of a projection lens in accordance with a second exemplary embodiment of the present disclosure.

FIG. 5 is a distortion curve of the projection lens in FIG. 4.

FIG. 6 is a spot diagram of the projection lens in FIG. 4.

FIG. 7 is an illustrative structural view of a projection lens in accordance with a third exemplary embodiment of the present disclosure.

FIG. 8 is a distortion curve of the projection lens in FIG. 7.

FIG. 9 is a spot diagram of the projection lens in FIG. 7.

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby is only to explain the disclosure, not intended to limit the disclosure.

### Embodiment 1

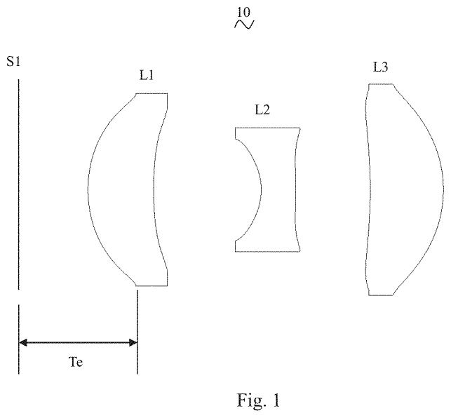

As referring to FIG. 1, the present invention provides a projection lens 10. FIG. 1 shows the camera optical lens 10 of a first embodiment of the present invention, the camera optical lens 10 comprises 3 lenses. Specifically, from the object side to the image side, the camera optical lens 10 comprises in sequence: an object surface S1, a first lens L1 with a positive refractive power, a second lens L2 with a negative refractive power, and a third lens L3 with a positive refractive power.

The first lens L1 has a positive refractive power thereby effectively reducing the system length of the projection lens 10. The first lens L1 has a convex object side surface (near an optic axis, the same hereinafter) and a concave image side surface. The second lens L2 has a negative refractive power with a concave object side surface and a convex image side surface. The third lens L3 has a positive refractive power with a concave object side surface and a convex image side surface.

Here, the focal length of the whole projection lens 10 is defined as f, and the total distance from the object side surface of the first lens to the image plane along the optic axis is defined as TTL. The total track length is a distance from the object surface S1 to the image side surface of the third lens L3 along the optic axis. A distance from the object surface S1 to an edge of the first lens L1 is defined as Te. Conditions 0.95≤f/TTL≤2, 0.22≤Te/TTL≤0.3 are satisfied. When the conditions are satisfied, the configurations of the refractive powers of the lenses can be adjusted, and the system length is reduced while satisfying telephoto and clear projection. Further, the light source keeps a greater distance from the edge of the lens for providing more flexible design tolerance. In addition, the system focal length is not sensitive to the circumstance temperature and is stable under different temperatures. The change of the angle of projection is not obvious, which greatly remain the light information.

Specific, in the embodiment, the condition 3.3 mm≤f≤4.5 mm is further satisfied, by which the TTL is reduced as possible. Preferably, 3.6 mm≤f≤3.8 mm is satisfied.

Preferably, the condition TTL≤3.2 mm is satisfied, which make it easy to miniaturize the lens. The condition 0.7 mm≤Te≤0.9 mm is further satisfied, by which the distance from the object surface to the edge of the first lens L1 is greater and more mounting space is provided for improving the structural stability of the system.

A focal length of the first lens L1 is defined as f1, and a focal length of the third lens is defined as f3. Condition 0.5≤f3/f1≤2 is satisfied, by which the refractive powers can be better distributed for miniaturizing the lens.

Further, a thickness of the second lens L2 on the optic axis is defined as d3, and a thickness of the third lens L3 on the optic axis is defined as d5. Condition 1≤d5/d3≤3 is satisfied, by which the second and third lenses are provided with preferable thicknesses for making it easy to assemble the system and miniaturize the system.

A curvature radius of an image side surface of the third lens L3 is defined as R6. Condition −6≤f/R6<0 is satisfied, which obviously reduce the sensitivity of the third lens L3.

Further, a curvature radius of an object side surface of the first lens L1 is defined as R1, and condition −3<R1/R6<0 is satisfied, which is beneficial to spherical aberration of the system.

Optionally, the first lens L1 is made of glass, and a change rate of a refraction index of the first lens L1 according to the temperature is defined as (dn/dt)1. Condition −0.00001<(dn/dt)1<0 is satisfied. When the temperature is changed, affection to the focal length caused by the expansion of the lens is counteracted by the affection to the focal length caused by the expansion of the structural elements, by which the sensitivity to the temperature is lowered and ensure the stability of the focal length of the system.

Optionally, the second lens L2 is made of plastic, and the third lens L3 is made of plastic, for obviously reducing the cost.

Optionally, surfaces of the lenses are aspherical for obtaining more controlling variables and reducing longitudinal aberration, and further reducing the quality of the lenses and reducing the total length of the lens.

Optionally, the object side surface or the image side surface of each of the lenses can be provided with inflexion points and arrest points for improving the image quality.

Design data of the projection lens of the first embodiment is shown below. Unit of the focal length, distance on optic axis, curvature radius, thickness on optic axis, inflexion point position, or arrest point position is millimeter (mm).

Table 1 and Table 2 provide the data of the lens 10.

TABLE 1
Focal length (mm)

| | |
|---|---|
| f | 3.699 |
| f1 | 1.594 |
| f2 | −0.791 |
| f3 | 1.609 |

### Where:

f: focal length of the projection lens 10;
f1: focal length of the first lens L1;
f2: focal length of the second lens L2;
f3: focal length of the third lens L3.

TABLE 2

| | | Curvature | Thickness/ | | Refractive | | Abbe | |
|---|---|---|---|---|---|---|---|---|
| | | Radius (R) | Distance (d) | | Index | | Number | |
| | | (mm) | (mm) | | (nd) | | (νd) | |
| S1 | | ∞ | d0 = | 0.522 | | | | |
| L1 | R1 | 0.8592971 | d1 = | 0.461 | nd1 | 1.7505 | ν1 | 45.48 |
| | R2 | 2.4981072 | d2 = | 0.756 | | | | |
| L2 | R3 | −0.406581 | d3 = | 0.243 | nd2 | 1.6614 | ν2 | 20.41 |
| | R4 | −2.624107 | d4 = | 0.522 | | | | |
| L3 | R5 | −3.610053 | d5 = | 0.514 | nd3 | 1.6614 | ν3 | 20.41 |
| | R6 | −0.840532 | d6 = | 300.00 | | | | |

### Where:

R: curvature radius of optical surface; central curvature radius for lens;
R1: curvature radius of the object side surface of the first lens L1;
R2: curvature radius of the image side surface of the first lens L1;
R3: curvature radius of the object side surface of the second lens L2;
R4: curvature radius of the image side surface of the second lens L2;
R5: curvature radius of the object side surface of the third lens L3;
R6: curvature radius of the image side surface of the third lens L3;
d: thickness of lens on the optic axis; distance between lenses on the optic axis;
d0: distance from the object surface to the object side surface of the first lens L1;
d1: thickness of the first lens L1 on the optic axis;
d2: distance from the image side surface of the first lens to the object side surface of the second lens L2 on the optic axis;
d3: thickness of the second lens L2 on the optic axis;
d4: distance from the image side surface of the second lens L2 to the object side surface of the third lens L3 on the optic axis;
d5: thickness of the third lens L3 on the optic axis;
d6: distance from the image side surface of the third lens L3 to an optic filter GF on the optic axis;
nd: refractive index of the d line;
nd1: refractive index of the d line of the first lens L1;
nd2: refractive index of the d line of the second lens L2;
nd3: refractive index of the d line of the third lens L3;
vd: \abbe number;
v1: abbe number of the first lens L1;
v2: abbe number of the second lens L2;
v3: abbe number of the third lens L3.

Table 3 provides the aspherical data of the projection lens 10 of the first embodiment.

TABLE 3

| | Conic Index | Aspherical Surface Index | | | | |
|---|---|---|---|---|---|---|
| | k | A4 | A6 | A8 | A10 | A12 |
| R1 | −1.1483E+00 | 3.3379E−01 | 1.5503E+00 | −9.7267E+00 | 3.7632E+01 | −7.1969E+01 |
| R2 | 1.8354E+01 | 1.1273E−01 | 2.6792E+00 | −2.5157E+01 | 9.2087E+01 | −5.6894E+01 |
| R3 | −1.5100E−01 | 2.4928E+00 | 6.8860E+00 | −1.0642E+02 | −1.5670E+02 | 6.8541E+03 |
| R4 | −9.9000E+01 | 1.5087E+00 | 1.0626E+01 | −1.5692E+02 | 1.4580E+03 | −8.6941E+03 |
| R5 | 5.8504E+00 | 5.0975E−02 | 6.7151E−02 | 1.3048E+00 | −6.0984E+00 | 1.8813E+01 |
| R6 | −4.4680E−01 | −9.5286E−02 | 5.1359E−01 | −3.6509E+00 | 1.3460E+01 | −2.5272E+01 |

| | Aspherical Surface Index | | | |
|---|---|---|---|---|
| | A14 | A16 | A18 | A20 |
| R1 | 5.1854E+01 | 2.7552E+01 | 8.1241E+01 | −3.7743E+02 |
| R2 | −7.3817E+01 | −1.2152E+03 | −1.2228E+03 | 9.1804E+03 |
| R3 | 3.2517E+03 | −5.7239E+04 | −1.6890E+06 | −1.2210E+07 |
| R4 | 2.9534E+04 | −1.2782E+04 | −3.8852E+05 | 1.0270E+06 |
| R5 | −1.9674E+01 | 3.9364E+00 | −9.9010E+00 | 1.6777E+01 |
| R6 | 2.1061E+01 | −1.6597E+00 | 3.8708E+00 | −1.9178E+00 |

### Where

k is conic index; A4, A6, A8, A10, A12, A14, A16 are aspheric surface indexes.
IH: Image height

y=(x²/R)/[1+{1−(k+1)(x²/R²)}^{1/2}]+A4x⁴+A6x⁶+A8x⁸+A10x¹⁰+A12x¹²+A14x¹⁴+A16x¹⁶ (1)

For convenience, the aspheric surface of each lens surface uses the aspheric surfaces shown in the above condition (1). However, the present invention is not limited to the aspherical polynomials form shown in the condition (1).

Table 4 show the inflexion points design data of the projection lens 10 lens in first embodiment of the present invention. In which, R1 and R2 represent respectively the object side surface and image side surface of the first lens L1, R3 and R4 represent respectively the object side surface and image side surface of the second lens L2, R5 and R6 represent respectively the object side surface and image side surface of the third lens L3. The data in the column named “inflexion point position” are the vertical distances from the inflexion points arranged on each lens surface to the optic axis of the camera optical lens 10.

TABLE 4

| | Quantity of | Inflexion Point | Inflexion Point |
|---|---|---|---|
| | Inflexion Points | Position 1 | Position 2 |
| R1 | 1 | 0.605 | |
| R2 | 2 | 0.485 | 0.535 |
| R3 | 0 | | |
| R4 | 2 | 0.125 | 0.395 |
| R5 | 1 | 0.415 | |
| R6 | 1 | 0.655 | |

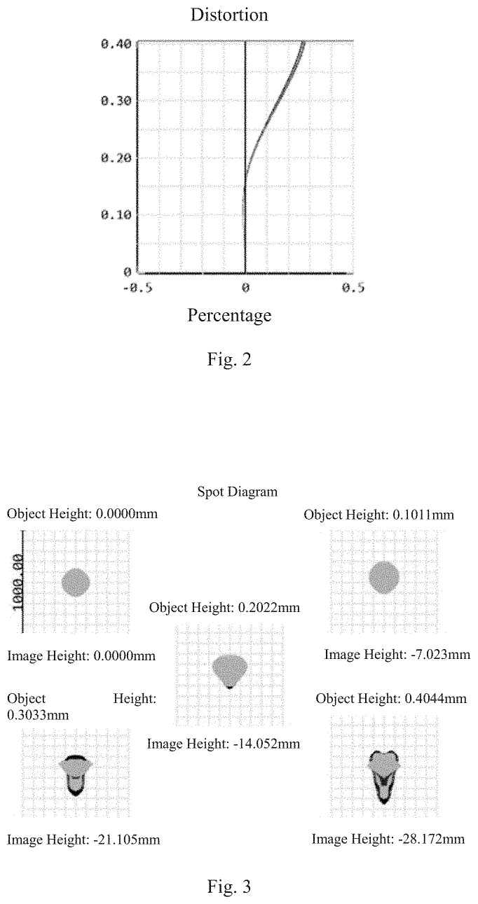

FIG. 2 shows the distortion of the projection lens 10 after light with a wavelength of 930 nm, 940 nm, 950 nm and 960 nm passes the projection lens 10 in the first embodiment. FIG. 3 shows the spot diagram of the projection lens 10 in the first embodiment.

Table 5 shows the various values of the embodiment and the values corresponding with the parameters which are already specified in the conditions.

TABLE 5

| Condition | Embodiment 1 |
|---|---|
| 0.95 < f/TTL < 2 | 1.228 |
| 0.22 < Te/TTL < 0.3 | 0.263 |
| 0.5 < f3/f1 < 2 | 1.008 |
| 1 < d5/d3 < 3 | 2.115 |
| −6 < f/r6 < 0 | −4.403 |
| −3 < r1/r6 < 0 | −1.021 |
| −0.00001 < dn1/dt < 0 | −6.26E−06 |
| dn2/dt < −0.00005 | −6.50E−05 |
| dn3/dt < −0.00005 | −6.50E−05 |
| Te | 0.793734 |

In this embodiment, the full vision field image height is 0.4044 mm, and the working distance is 300 mm.

### Embodiment 2

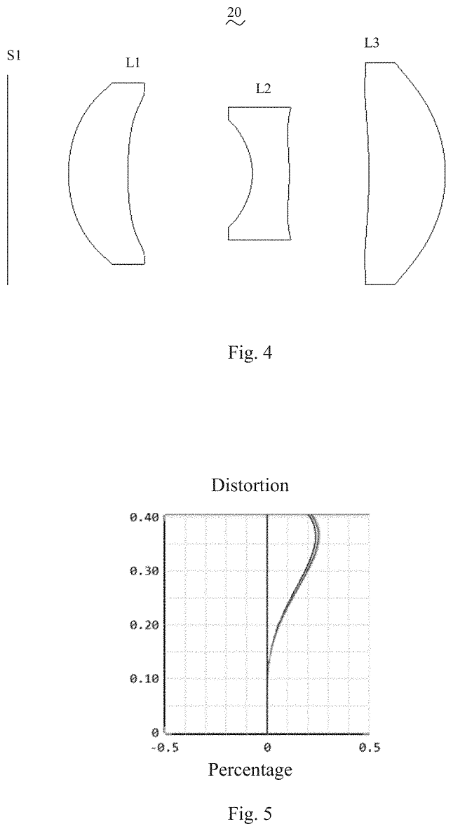

The lens 20 in FIG. 4 of Embodiment 2 is basically the same as embodiment 1, the meaning of its symbols is the same as that of embodiment 1, in the following, only the differences are described.

Table 6 and table 7 show the design data of the projection lens 20 in embodiment 2 of the present invention.

TABLE 6
Focal Length (mm)

| | |
|---|---|
| f | 3.700 |
| f1 | 1.701 |
| f2 | −0.921 |
| f3 | 1.720 |

TABLE 7

| | | Curvature | Thickness/ | | Refractive | | Abbe | |
|---|---|---|---|---|---|---|---|---|
| | | Radius (R) | Distance (d) | | Index | | Number | |
| | | (mm) | (mm) | | (nd) | | (νd) | |
| S1 | | ∞ | d0 = | 0.486 | | | | |
| L1 | R1 | 0.879487 | d1 = | 0.404 | nd1 | 1.7505 | ν1 | 45.483 |
| | R2 | 2.3534999 | d2 = | 0.847 | | | | |
| L2 | R3 | −0.41334 | d3 = | 0.250 | nd2 | 1.6614 | ν2 | 20.412 |
| | R4 | −1.754758 | d4 = | 0.542 | | | | |
| L3 | R5 | −4.036503 | d5 = | 0.520 | nd3 | 1.6614 | ν3 | 20.412 |
| | R6 | −0.900289 | d6 = | 300.000 | | | | |

Table 8 shows the aspherical surface data of each lens in embodiment 2 of the present invention.

TABLE 8

| | Conic Index | Aspherical Surface Index | | | | | | |
|---|---|---|---|---|---|---|---|---|
| | k | A4 | A6 | A8 | A10 | A12 | A14 | A16 |
| R1 | −9.2789E−01 | 3.8215E−01 | 1.6760E+00 | −9.5834E+00 | 3.7821E+01 | −7.0598E+01 | 5.5992E+01 | 1.3754E+01 |
| R2 | 1.5280E+01 | 2.2951E−01 | 3.1462E+00 | −2.3617E+01 | 9.3629E+01 | −5.8736E+01 | −1.2126E+02 | −1.3606E+03 |
| R3 | −2.2727E−01 | 2.5122E+00 | 4.0525E+00 | −7.1402E+01 | −6.2681E+02 | 8.5602E+03 | 3.9105E+04 | −3.8444E+05 |
| R4 | −8.9853E+01 | 1.1378E−01 | 2.1589E+01 | −2.2248E+02 | 1.5224E+03 | −7.8839E+03 | 2.9049E+04 | −2.4196E+04 |
| R5 | 1.2811E+01 | 1.0105E−01 | −6.1105E−02 | 1.3407E+00 | −5.3496E+00 | 1.5416E+01 | −2.3403E+01 | 1.8066E+01 |
| R6 | −3.9711E−01 | −7.8809E−02 | 6.5572E−01 | −4.1799E+00 | 1.4391E+01 | −2.4441E+01 | 1.5978E+01 | 1.0934E+00 |

Inflexion design data of the lens 20 lens in embodiment 2 of the present invention is shown in Table 9.

TABLE 9

| | Quantity of Inflexion Points | Inflexion Point Position 1 |
|---|---|---|
| R1 | 1 | 0.585 |
| R2 | 1 | 0.485 |
| R3 | 0 | |
| R4 | 1 | 0.155 |
| R5 | 1 | 0.415 |
| R6 | 1 | 0.685 |

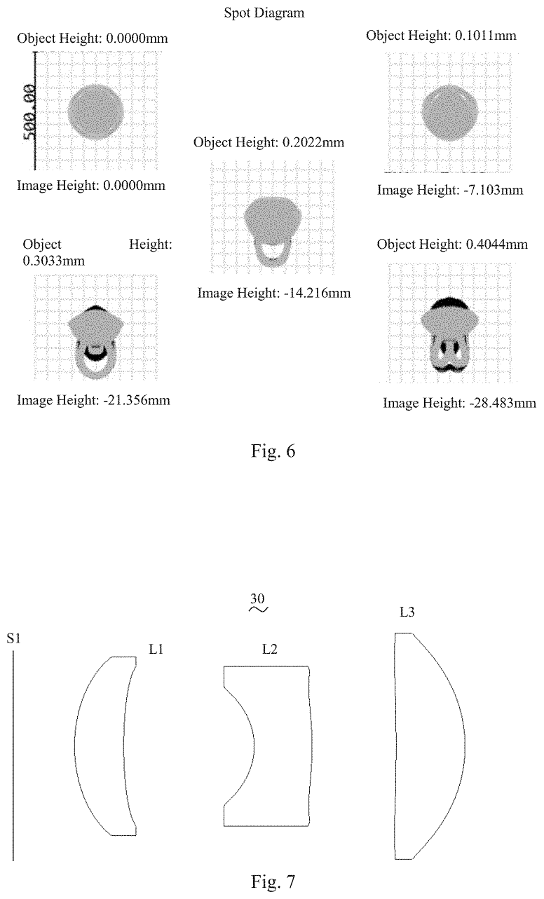

FIG. 5 shows the distortion of the projection lens 20 after light with a wavelength of 930 nm, 940 nm, 950 nm and 960 nm passes the projection lens 20 in the second embodiment. FIG. 6 shows the spot diagram of the projection lens 20 in the second embodiment.

As shown in Table 10, the second embodiment satisfies the various conditions.

TABLE 10

| Condition | Embodiment 2 |
|---|---|
| 0.95 < f/TTL < 2 | 1.214 |
| 0.22 < Te/TTL < 0.3 | 0.253 |
| 0.5 < f3/f1 < 2 | 1.012 |
| 1 < d5/d3 < 3 | 2.08 |
| −6 < f/r6 < 0 | −4.11 |
| −3 < r1/r6 < 0 | −0.977 |
| −0.00001 < dn1/dt < 0 | −6.26E−06 |
| dn2/dt < −0.00005 | −6.50E−05 |
| dn3/dt < −0.00005 | −6.50E−05 |
| Te | 0.771397 |

In this embodiment, the full vision field image height is 0.4044 mm, and the working distance is 300 mm.

### Embodiment 3

The lens 30 in FIG. 7 of Embodiment 3 is basically the same as embodiment 1, the meaning of its symbols is the same as that of embodiment 1, in the following, only the differences are described.

Table 11 and table 12 show the design data of the projection lens 30 in embodiment 3 of the present invention.

TABLE 11
Focal Length (mm)

| | |
|---|---|
| f | 3.700 |
| f1 | 1.733 |
| f2 | −0.971 |
| f3 | 1.836 |

TABLE 12

| | | Curvature | Thickness/ | | Refractive | | Abbe | |
|---|---|---|---|---|---|---|---|---|
| | | Radius (R) | Distance (d) | | Index | | Number | |
| | | (mm) | (mm) | | (nd) | | (νd) | |
| S1 | | ∞ | d0 = | 0.451 | | | | |
| L1 | R1 | 0.9770952 | d1 = | 0.331 | nd1 | 1.8061 | L1 | R1 |
| | R2 | 2.9291518 | d2 = | 0.877 | | | | R2 |
| L2 | R3 | −0.431374 | d3 = | 0.389 | nd2 | 1.6614 | L2 | R3 |
| | R4 | −1.952794 | d4 = | 0.565 | | | | R4 |
| L3 | R5 | −12.22704 | d5 = | 0.464 | nd3 | 1.5445 | L3 | R5 |
| | R6 | −0.919254 | d6 = | 300.000 | | | | |

Table 13 shows the aspherical surface data of each lens in embodiment 2 of the present invention.

TABLE 13

| | Conic Index | Aspherical Surface Index | | | | | | |
|---|---|---|---|---|---|---|---|---|
| | k | A4 | A6 | A8 | A10 | A12 | A14 | A16 |
| R1 | −9.7211E−01 | 2.3947E−01 | 1.6051E+00 | −1.1256E+01 | 4.2328E+01 | −6.4529E+01 | 4.4458E+01 | −1.9033E+01 |
| R2 | 8.8960E+00 | 8.8899E−02 | 1.5625E+00 | −1.4149E+01 | 6.7882E+01 | −1.2290E+02 | 8.4344E+01 | 5.7951E−01 |
| R3 | −3.3072E−01 | 3.2634E−01 | −3.9219E+00 | 9.3088E+01 | −4.2890E+02 | 3.5140E+02 | −6.3389E+03 | −3.3999E+04 |
| R4 | −3.8437E+00 | 2.0671E−01 | 1.3251E+01 | −2.0452E+02 | 1.7907E+03 | −8.5468E+03 | 2.1219E+04 | −2.1646E+04 |
| R5 | 8.0423E+01 | 5.1553E−02 | −3.5996E−01 | 1.4827E+00 | −5.1866E+00 | 1.6405E+01 | −2.5322E+01 | 1.4760E+01 |
| R6 | −1.7197E−01 | −1.0749E−01 | 1.1022E+00 | −5.4107E+00 | 1.4660E+01 | −2.1973E+01 | 1.8031E+01 | −5.8227E+00 |

Inflexion design data of the lens 30 lens in embodiment 3 of the present invention is shown in Table 14.

TABLE 14

| | Quantity of | Inflexion Point | Inflexion Point |
|---|---|---|---|
| | Inflexion Points | Position 1 | Position 2 |
| R1 | 0 | | |
| R2 | 0 | | |
| R3 | 1 | 0.375 | |
| R4 | 2 | 0.245 | 0.465 |
| R5 | 1 | 0.485 | |
| R6 | 1 | 0.705 | |

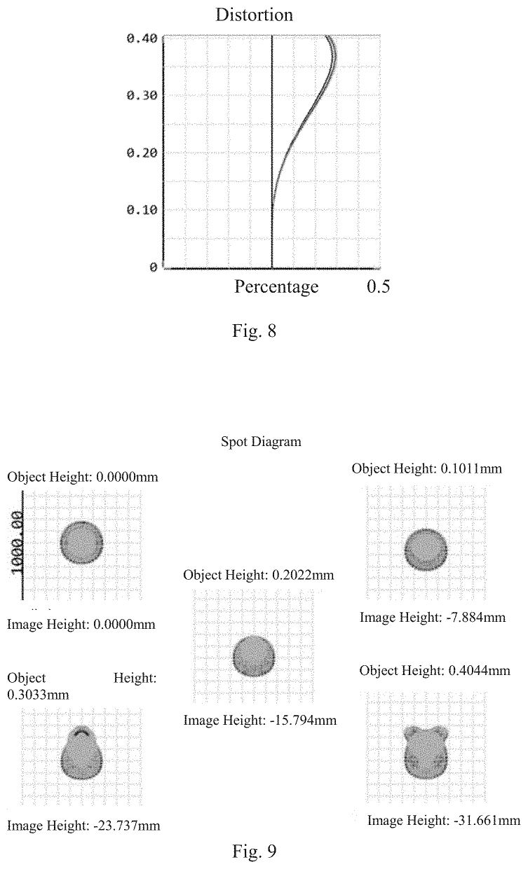

FIG. 8 shows the distortion of the projection lens 30 after light with a wavelength of 930 nm, 940 nm, 950 nm and 960 nm passes the projection lens 30 in the third embodiment. FIG. 9 shows the spot diagram of the projection lens 30 in the third embodiment.

As shown in Table 15, the second embodiment satisfies the various conditions.

TABLE 15

| Condition | Embodiment 3 |
|---|---|
| 0.95 < f/TTL < 2 | 1.203 |
| 0.22 < Te/TTL < 0.3 | 0.26 |
| 0.5 < f3/f1 < 2 | 1.06 |
| 1 < d5/d3 < 3 | 1.193 |
| −6 < f/r6 < 0 | −4.025 |
| −3 < r1/r6 < 0 | −1.093 |
| −0.00001 < dn1/dt < 0 | −6.26E−06 |
| dn2/dt < −0.00005 | −6.50E−05 |
| dn3/dt < −0.00005 | −6.50E−05 |
| Te | 0.79976 |

In this embodiment, the full vision field image height is 0.4044 mm, and the working distance is 300 mm.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A projection lens comprising, from an object side to an image side in sequence: an object surface, a first lens with a positive refractive power, a second lens with a negative refractive power, a third lens with a positive refractive power; wherein the projection lens further satisfies the following conditions:
0.95≤f/TTL≤2;
0.22≤Te/TTL≤0.3;
where
f: focal length of the projection lens;
TTL: the total distance from the object side surface of the first lens to the image plane along the optic axis;
Te: distance from the object surface to an edge of the first lens.

2. The projection lens as described in claim 1 further satisfying the condition:
TTL≤3.2 mm.

3. The projection lens as described in claim 1 further satisfying the condition:
3.3 mm≤f≤4.5 mm.

4. The projection lens as described in claim 3 further satisfying the condition:
3.6 mm≤f≤3.8 mm.

5. The projection lens as described in claim 1 further satisfying the condition:
0.7 mm≤Te≤0.9 mm.

6. The projection lens as described in claim 1 further satisfying the condition:
0.5≤f3/f1≤2;
where
f1: focal length of the first lens;
f3: focal length of the third lens.

7. The projection lens as described in claim 1 further satisfying the condition:
1≤d5/d3≤3; where
d3: thickness of the second lens on optic axis;
d5: thickness of the third lens on optic axis.

8. The projection lens as described in claim 1 further satisfying the condition:
−6≤f/R6≤0; where
R6: curvature radius of an image side surface of the third lens.

9. The projection lens as described in claim 1 further satisfying the condition:
−3≤R1/R6≤0; where
R1: curvature radius of an object side surface of the first lens;
R6: curvature radius of an image side surface of the third lens.

10. The projection lens as described in claim 1 further satisfying the condition:
−0.00001<(dn/dt)1<0; where
dn/dt: change rate of refractive index of the first lens made of glass according to the change of temperature.

11. The projection lens as described in claim 1, wherein the second lens is made of plastic, and the third lens is made of plastic.
